(19) United States
(12) Patent Application Publication
(10) Pub. No.: US 2011/0265979 A1
(43) Pub. Date: Nov. 3, 2011

(54) THERMAL INTERFACE MATERIALS WITH GOOD RELIABILITY

(76) Inventors: SIHAI CHEN, NewHartford, NY (US); NING-CHENG LEE, New Hartford, NY (US)

(21) Appl. No.: 13/097,443

(22) Filed: Apr. 29, 2011

Related U.S. Application Data
(60) Provisional application No. 61/330,220, filed on Apr. 30, 2010.

(51) Int. Cl. F28F 7/00; B23P 15/00; C09K 5/00

(52) U.S. Cl. 165/185; 252/73; 29/428

(57) ABSTRACT

A composition for a highly reliable thermal interface materials includes: (A) moisture-resistant polymer with a water permeability coefficient preferably less than 10⁻¹¹ cm³ (STP) cm/cm² S Pa, (B) gas barrier polymer having oxygen permeability coefficient preferably less than 10⁻¹⁴ cm³ (STP) cm/cm² S Pa, (C) antioxidant, (D) thermal conductive filler and (E) other additive or optional materials. The thermal interface materials placed in between the thermal generating and dissipating devices can effectively barrier water and oxygen penetration, preventing the thermal fillers from degradation and improving the reliability of the devices.

### RELATED APPLICATION

This application claims the benefit of U.S. Provisional Application No. 61/330,220, which was filed on Apr. 30, 2010 and which is hereby incorporated herein by reference in its entirety.

### TECHNICAL FIELD

The present invention relates generally to thermal interface materials, and more particularly, some embodiments relate to polymer-based thermal interface materials for use in integrated circuit applications.

### DESCRIPTION OF THE RELATED ART

Increased demand for smaller, faster and more powerful electronic products using integrated circuits has driven the development of more powerful and smaller semiconductor devices. A critical issue is that the heat generated from these devices should be promptly and adequately removed to avoid overheating and subsequent damage to the devices. Heat management devices such as integrated heat sinks or heat pipes are normally used to spread the heat away from power generating devices. Between the heat sink and the semiconductor devices, a layer of thermal interface material can be utilized to facilitate the heat transfer. The thermal interface materials generally conduct heat better than air and are positioned to fill the gaps between the semiconductor devices and the heat sinks to increase thermal transfer efficiency. Common thermal interface materials can include thermal grease, such as silicone oil filled with aluminum oxide, zinc oxide, or boron nitride. Some thermal interfaces also use micronized or pulverized silver. Phase-change materials—materials that are solid at or near room temperature but have a melting point such that they liquefy at or below operating temperatures—are also used. Such materials can be easy to apply, as they are in the solid state during application.

Conventionally, thermal greases have been widely available on the market due to their good thermal performance upon installation. However, upon extended use and over time, these greases can degrade, resulting in higher thermal resistance at the interface. This impairs the transfer of heat away from the semiconductor device. This problem has been attributed to two main causes which are sometimes referred to as “pump-out” and “dry-out.” The powering up and down of the devices causes a relative motion between the die and the heat-spreader due to their different coefficients of thermal expansion. This can tend to “pump” out the paste from the interface gap. Grease “dry out” occurs when the fillers separate from the organic matrix and the organics flow out at elevated temperature. This results in delamination of the interface materials, lowering the reliability of the devices.

There are several published articles and other publications addressing the reliability issue of the thermal interface materials. In one example, U.S. Pat. No. 6,597,575 disclosures a composition comprising cured silicone-based gel where the polymer matrix is a crosslinked silicone polymer. This document describes that the optimized gel materials should have a storage shear modulus (G′) at 125° C. of less than about 100 kPa, and to have a gel point, as indicated by a value for G′/G″ of greater than or equal to 1, where G″ is the loss shear modulus of the thermal interface material. The document claims that thermal materials with proper mechanical properties could be used to avoid delamination and to meet the reliability and performance requirements.

U.S. Pat. No. 6,791,839 describes a curable thermal interface material based on a silicone polymer matrix. In the described 85° C., 85% relative humidity chamber test, the thermal impedance of the silicone-based materials increases nearly one order of magnitude after 35 clays of treatment, which indicates that the oxidative stability of the materials is very low.

U.S. Pat. No. 6,813,153 describes polymer solder hybrid thermal interface materials, in which a solder with low melting point was added into a composition containing polymer and a filler with a high melting temperature, the polymers are normally referred to as epoxy or siloxane based organics such as polydimethyl siloxane (PDMS) or poly-(dimethyl diphenyl siloxane). It is claimed that upon reflow the high melting point filler diffuses into the solder to form a new filler-solder alloy having an increased melting point and added robustness. These materials use a reflow process prior to real-time application, which increases the complexity and processing cost.

In another example, U.S. Pat. No. 7,408,787 reported a phase change material comprising a polyester such as polycaprolactone which has a melting point from slightly above room temperature (such as 40° C.) to near or below operating temperature (such as 130″C), a thermal conductive filler with bulk thermal conductivity greater than about 50 W/mK and other optional additives. This document describes that the material has a higher thermal decomposition temperature than that of the polyolefin as judged from thermal gravimetric analysis.

In summary, conventional technologies provide several means to improve the reliability of thermal interface materials. Many of them still use a silicone-based polymer as the main matrix. The last reference (U.S. Pat. No. 7,408,787) uses phase-change materials. However, silicone-based polymers normally have high permeability to both oxygen and water; and are not a preferred material suitable for highly reliable thermal interface materials. The phase change materials, due to the formation of the liquid phase, are easily pumped out especially when the interface is vertically positioned.

### BRIEF SUMMARY OF EMBODIMENTS OF THE INVENTION

According to various embodiments of the invention thermal paste materials are provided. These materials can be used, in some embodiments as a thermal interface material. Embodiments of the invention can be configured to provide thermal stability and good reliability upon highly accelerated stress test (HAST) treatment. Embodiments of the materials are thermally stable in air and moisture under high temperature environment, and are able to prevent the air or moisture from penetrating the interface to degrade the filler materials. This allows the materials to pass extensive reliability tests, such as baking, 85° C. and 85% humidity chamber, and power cycling. In some embodiments, the materials use thermally stable polymers with both oxygen and moisture barrier properties.

In one embodiment, the thermal interface materials comprise (A) moisture-resistant polymer, (B) gas harrier polymer having low oxygen permeability, (C) antioxidant, (D) thermal conductive filler and (E) other additive or optional materials. The antioxidants are used to hinder thermally induced oxidation of polymers, and thus enhance their thermal stability.

According to an embodiment of the invention a thermal interface material, that includes a polymer having a water permeability coefficient less than about 10⁻¹¹ cm³ (STP) cm/cm² S Pa; a polymer having an oxygen permeability coefficient less than about 10⁻¹⁴ cm³ (STP) cm/cm² S Pa; an antioxidant; and a thermally conductive filler. A solvent or low molecular weight hydrocarbon resin can also be added to the material. In one embodiment, the polymer having the water permeability coefficient less than about 10⁻¹¹ cm³ (STP) cm/cm² S Pa and the polymer having an oxygen permeability coefficient less than about 10⁻¹⁴ cm³ (STP) cm/cm² S Pa are the same polymer.

In another embodiment, an assembly can be made using the thermal paste disclosed herein. For example, a thermal generating device, such as a semiconductor or other electronic circuit element can be provided. A thermal dissipation device, such as a heat sink, heat pipes or other like device can also be provided as a mechanism to remove heat from the electronic element. The thermal paste disclosed herein is disposed between the heat generating device and the thermal dissipating device to facilitate heat transfer therebetween.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating the water and oxygen permeability coefficients of different polymers with water permeability coefficient increasing from left to right. Polymers near the left axis have low water permeability. The y-axis shows O₂ and H₂O permeability coefficient (P×10¹³) (cm³(STP)cm/cm² S Pa).

FIG. 2. The water and oxygen permeability coefficients of different polymers with oxygen permeability coefficient increasing from left to right. Polymers near the left axis have low oxygen permeability. The y-axis shows O₂ and H₂O permeability coefficient (P×10¹³) (cm³(STP)cm/cm² S Pa).

### DETAILED DESCRIPTION OF THE EMBODIMENTS OF THE INVENTION

The present invention provides novel thermal paste materials to be used, in some embodiments as a thermal interface material. Embodiments of the invention can be configured to provide thermal stability and good reliability upon highly accelerated stress test (HAST) treatment. Embodiments of the materials are thermally stable in air and moisture under high temperature environment, and are able to prevent the air or moisture from penetrating the interface to degrade the filler materials. This allows the materials to pass extensive reliability tests, such as baking, 85° C. and 85% humidity chamber, and power cycling. In some embodiments, the materials use thermally stable polymers with both oxygen and moisture barrier properties.

In one embodiment, the thermal interface materials comprise (A) moisture-resistant polymer, (B) gas barrier polymer having low oxygen permeability, (C) antioxidant, (D) thermal conductive filler and (E) other additive or optional materials. The antioxidants are used to hinder thermally induced oxidation of polymers, and thus enhance their thermal stability. The polymers with low oxygen and water permeability are used to protect the thermal fillers from contacting with environmental oxygen and moisture, and thus prevent the fillers from oxidation or decomposition. In some embodiments, the thermal interface materials are not phase change materials, and remain in the same phase during device operation.

In some embodiments, the polymers (A) of low water permeability, preferably with permeability coefficient smaller than 10⁻¹¹ cm³ (SUP) cm/cm² S Pa include polyolefin, poly(alkanes), poly(alkenes), polyamide, and fluorine or chlorine containing polymer. In further embodiments, the polyolefin, poly(alkanes) or poly(alkenes) having good moisture barrier properties comprise a polymer prepared from monomer with 2 to 10 carbon atoms and particular 2 to 6 carbon atoms, such as ethylene, propylene, butane-1, butadiene, 4-methyl pentene-1 hexane, or a copolymer of two or more of these olefins. In still further embodiments, an ethylene alpha olefin copolymer, ethylene propylene copolymer, rubber modified ethylene propylene copolymer, or ethyene propylene butene terpolymer, or blends thereof, can be used. In a particular embodiment, a suitable material is polypropylene or polyethylene with crystalline or amorphous phase. Alternatively, a copolymer between polyethylene and polypropylene, or a copolymer using tri-monomers such as poly(dienes), or poly(ethylene-co-propylene-co-diene) butyl rubber can also be used.

In some embodiments, suitable polyamide materials includes, but not limited to for example, poly(imino-1-oxaundecamethylene) (nylon 6).

In some embodiments, suitable fluorine or chlorine containing polymer includes, for examples, poly(tetrafluoroethylene-co-hexafluoropropene) Teflon FEP, poly(tetrafluoroethylene) Hostaflon PFA; poly(vinyl fluoride) Tedlar; poly(trifluorochloroethylene-co-ethylene) Halar; poly(tetrafluoroethylene) Hostaflon PFA, poly(tetrafluoroethylene-co-ethylene) Hostaflon ET; and poly(vinylidene chloride) Saran. Other suitable materials for the substrate include chlorotrifluoroethylene-vinylidene fluoride copolymer (CTFE/VDF), ethylene-chlorotrifluoroethylene copolymer (ECTFE), ethylene-tetrafluoroethylene copolymer (ETFE), fluorinated ethylene-propylene copolymer (FEP), polychlorotrifluoroethylene (PCTFE), perfluoroalkyl-tetrafluoroethylene copolymer (PEA), polytetrafluoroethyloene (PTFE), polyvinylidene fluoride (PVDF), polyvinyl fluoride (PVF), tetrafluoroethylene-hexafluoropropylene copolymer (TEE/HFP), tetrafluoroethylene-hexafluoropropylene-vinylidene fluoride terpolymer (THV), polychlorotrifluoroethylene (PCTFE), hexafluoropropylene-vinylidene fluoride copolymer (HFP/VDF), tetrafluoroethylene-propylene copolymer (TFE/P), and tetrafluoroethylene-perfluoromethylether copolymer (TFE/PFMe).

In some embodiments, the polymers (13) with low oxygen permeability, preferably with oxygen permeability coefficient smaller than 10⁻¹⁴ cm³ (STP) cm/cm² S Pa, include poly(alkanes). i.e., high density poly(ethylene), HDPE; poly(methacrylates), i.e., poly(methyl methacrylate), poly(ethyl methacrylate); poly(nitriles). i.e., poly(acrylonitrile), poly(methacrylonitrile), poly(methacrylonitrile-co-styrene) Lopac, poly(acrylonitrile-co-styrene) Barex, polyacrylonitrile-co-methyl acrylate-co-butadiene); poly(vinyls), i.e., poly(vinylidene chloride) Saran, poly(vinyl chloride) unplasticized; fluorine containing polymers, i.e., poly(vinyl fluoride) Tedlar, poly(trifluorochloroethylene) unplasticized, poly(tritluorochloroethylene-co-ethylene) Halar, poly(tetrafluoroethylene-co-ethylene) Hostaflon ET; poly(dienes), i.e., poly(ethylene-co-propylene-co-diene) butyl rubber; poly(oxides), i.e. poly(oxymethylene) grafted with butadiene Hostaform; poly(esters) or poly(carbonates), i.e., poly(oxyethyleneoxyterephthaloyl) Hostaphan, poly(oxyethyleneoxyterephthaloyl) Mylar A, poly(oxycarbonyloxy-1,4-phenyleneisopropylidene-1,4-phenylene) Lexan; poly(amides), i.e., poly(imino-1-oxaundecamethylene) nylon 6, cellulose and derivatives. i.e., cellulose hydrate or Cellophane.

TABLE 1
Polymers used for comparison
of permeability to oxygen or water

| # | POLYMER |
|---|---|
| 1 | poly(imino-1-oxaundecamethylene) nylon 6, T12 |
| 2 | poly(trifluorochloroethylene), T6 |
| 3 | poly(trifluorochloroethylene-co-ethylene) Halar, T6 |
| 4 | poly(vinylidene chloride) Saran, T5 |
| 5 | poly(ethylene) HDPE, T1 |
| 6 | poly(vinyl fluoride) Tedlar, T6 |
| 7 | poly(tetrafluoroethylene-co-hexafluoropropene) Teflon FEP, T6 |
| 8 | poly(tetrafluoroethylene) Hostaflon PFA, T6 |
| 9 | trespaphan GND, T1 |
| 10 | poly(propylene), T1 |
| 11 | poly(ethylene) LDPE, T1 |
| 12 | poly(tetrafluoroethylene-co-ethylene) Hostaflon ET, T6 |
| 13 | poly(oxyethyleneoxyterephthaloyl) Mylar A, T10 |
| 14 | poly(oxyethyleneoxyterephthaloyl) Hostaphan, T10 |
| 15 | poly(ethylene-co-propylene-co-diene) butyl rubber, T7 |
| 16 | poly(vinyl chloride), unplasticized, T5 |
| 17 | poly(acrylonitrile), T4 |
| 18 | Lopac, T4 |
| 19 | poly(methacrylonitrile), T4 |
| 20 | poly(methacrylonitrile-co-styrene) 97/3, T4 |
| 21 | poly(isoprene) vulcanized purified gutta percha, T7 |
| 22 | kapton, T12 |
| 23 | poly(methacrylonitrile-co-styrene-co-butadiene) 88/7/5, T4 |
| 24 | poly(methyl methacrylate), T3 |
| 25 | Barex, T4 |
| 26 | poly(acrylonitrile-co-styrene) 86/14, T4 |
| 27 | poly(chloroprene) Neoprene G, T7 |
| 28 | poly(oxymethylene) grafted with 2.8% butadiene Hostaform, T9 |
| 29 | poly(acrylonitrile-co-methyl acrylate-co-butadiene) 79/15/6, T4 |
| 30 | poly(oxycarbonyloxy-1,4-phenyleneisopropylidene-1,4- |
| | phenylene) Lexan, T10 |
| 31 | poly(styrene), biaxially oriented, T2 |
| 32 | poly(isoprene) amorphous, nature rubber, T7 |
| 33 | poly(ethyl methacrylate), T3 |
| 34 | poly(oxy-2,6-dimethyl-1,4-phenylene), T9 |
| 35 | cellulose acetate, T13 |
| 36 | cellulose nitrate, T13 |
| 37 | ethyl cellulose, T13 |
| 38 | Cellulose hydrate, Cellophane, T13 |
| 39 | poly(oxydimethylsilylene) with 10% filler Scantocel CS, |
| | vulcanized silicon rubber, T11 |

```
  T1: poly(alkanes);
  T2: poly(styrene);
  T3: poly(methacrylates);
  T4: poly(nitriles);
  T5: poly(vinyls);
  T6: fluorine containing polymers;
  T7: poly(dienes);
  T8: poly(xylylene);
  T9: poly(oxides);
T10: poly(esters), poly(carbonates);
T11: poly(siloxanes);
T12: poly(amides), poly(imides);
T13: cellulose and derivatives
```

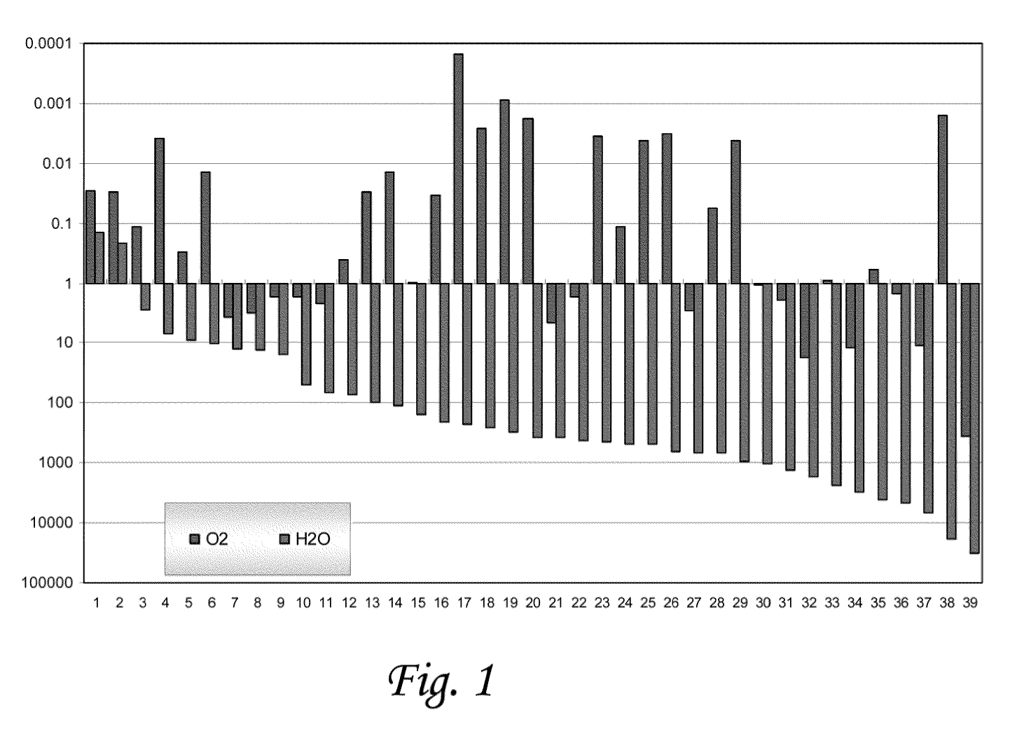

FIG. 1 is a diagram illustrating the water and oxygen permeability coefficients of different polymers with water permeability coefficient increasing from left to right. Polymers near the left axis have low water permeability. The y-axis shows O₂ and H₂O permeability coefficient (P×10¹³) (cm³(STP)cm/cm² S Pa).

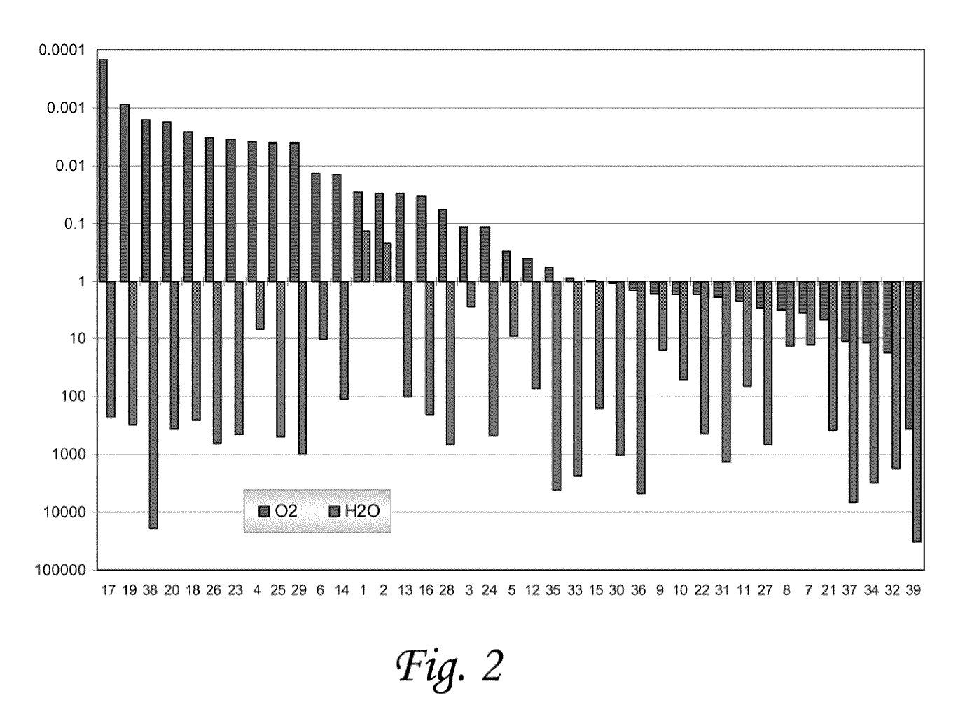

FIG. 2. The water and oxygen permeability coefficients of different polymers with oxygen permeability coefficient increasing from left to right. Polymers near the left axis have low oxygen permeability. The y-axis shows O₂ and H₂O permeability coefficient (P×10¹) (cm³(STP)cm/cm² S Pa).

As examples, Table 1 presents a series of polymers, the permeability coefficients to water and oxygen of which are given in FIGS. 1 and 2. From FIG. 1, it was found that the polymers having a low water permeability, in many cases also have a low oxygen permeability. These polymers include nylon 6, poly(trifluorochloroethylene), poly(trifluorochloroethylene-co-ethylene (Halar), poly(vinylidene chloride) (Saran), High density polyethylene, polyvinyl fluoride (Tedlar), poly(tetrafluoroethylene-co-hexafluoropropene (Tefon), poly(tetrafluoroethylene) (Hostaflon), trespaphan, low density poly(propylene). Therefore, in this case, one polymer, such as nylon 6, poly(trifluorochloroethylene), poly(vinylidene chloride) and polyvinyl fluoride can act as both oxygen and moisture blocking agent, and can be used individually.

From FIG. 2, polymers bearing the lowest oxygen permeability such as poly(acrylonitrile) and related materials normally have a high water permeability. In order to achieve low permeability with both water and oxygen, typical embodiments comprise at least one polymer from each of the above two groups to form the mixture. In further embodiments, use of more than one polymer from each group is also useful if desired thermal stability needs to be enhanced.

In order to protect the polymer from oxidation, some embodiments employ the addition of antioxidants (C). In various embodiments, many antioxidants can be applied, such as phenolic type IRGANOX 1010, 1076, 245 from Ciba Specialty Chemicals; ETHANOX 310, 314, 323A, 330, 376 from Albemarle Corp.; CYANOX 425, 1790, 2246 from Cytec Industries Inc.; SUMILIZER GS(F), GA-80, WX-R from Sumitomo Chemical Corp. Phosphite type such as IRGAFOS 168, IRGAFOS 126 from Ciba Specialty Chemicals; ETHAPHOS 368 from Albemarle Corp. Phenolic/Phosphite mixed type IRGANOX 13225 from Ciba Specialty Chemicals; ETHAPHOS 326 from Albemarle Corp., CYANOX 2777 from Cytec Industries. Inc. and SUMILIZER GP from Sumitomo Chemical Corp. Lactone/Phosphite mixed type IRGAFOS XP60 from Ciba Specialty Chemicals Lactone/Phosphite/Phenolic mixed type IRGANOX XP 620 from Ciba Specialty Chemicals. Sulfide such as CYANOX 711, 1212, from Cytec Industries: SUMILIZER TPL-R, IPM, TPS, TP-D from Sumitomo Chemical Corp.

In some embodiments, a polymer with low oxygen permeability is not used. For example, for filler materials (D) that are stable under air or oxygen atmosphere up to 300° C., such as ceramic, semiconductor and some precious metal materials, i.e., ZnO, Al₂O₃, BN, AlN, SiC, SiO₂, Si₃N₄, MgO, ZrO₂, MgAl₂O₄, WC, diamond, carbon nanotube, graphite, Ag, Au and Pt etc, it is not critical to choose a polymer with low oxygen permeability. These embodiments can still have a polymer with low water permeability because in many cases, a chemical reaction occurs between the filler materials and water that results in the decomposition or deterioration of the fillers. For example, Al₂O₃ or ZnO will degrade to aluminates or zincates in the presence of water and acid or base.

In other embodiments employing oxygen sensitive materials, such as metal particle fillers, the presence of oxygen or water will initiate or accelerate the surface oxidation process, and thus damage the filler materials and increase the thermal resistance of the materials. In these cases, the use of a polymer with both low water and oxygen permeability is desirable for all the thermal paste preparation.

Metal materials normally have a high thermal conductivity as compared to that of the ceramic materials. For individual metal materials, the oxidation normally results in the formation of a metal oxide with a lower thermal conductivity. This can be easily observed from Table 2.

TABLE 2
Thermal conductivity of some metals and their
corresponding metal oxides at room temperature.

| | kₘₑₜₐₗ | | K_{oxide} | |
|---|---|---|---|---|
| | (W/m- | Metal | (W/m- | K_{oxide}/ |
| Metal | K) | Oxide | K) | kₘₑₜₐₗ |
| Be | 216 | BeO | 125 | 57.9% |
| Mg | 159 | MgO | 21.5 | 13.5% |
| Al | 300 | Al₂O₃ | 46 | 15.3% |
| Si | 124 | SiO₂ | 6.4 | 5.16% |
| K | 99.2 | K₂O | 2.17 | 2.19% |
| Ca | 126 | CaO | 13.06 | 10.4% |
| Sr | 35.4 | SrO | 8.63 | 24.4% |
| Sn | 85 | SnO₂ | 17.5 | 20.6% |
| Ba | 18.4 | BaO | 2.89 | 15.7% |
| Pb | 39.6 | PbO | 1.6 | 4.04% |
| Ti | 31.2 | TiO₂ | 5.6 | 18% |
| Fe | 76.2 | Fe₃O₄ | 1.39 | 1.82% |
| Co | 69.21 | Co₂O₃ | 8 | 11.6% |
| Cu | 483 | CuO | 10.2 | 2.11% |
| Zn | 132 | ZnO | 16.8 | 12.7% |
| Y | 14.6 | Y₂O₃ | 2.15 | 14.7% |
| Zr | 16.7 | ZrO₂ | 2.45 | 14.7% |
| Hf | 22 | HfO₂ | 0.00037 | 1.68 × 10⁻⁷% |
| Ta | 54.5 | Ta₂O₅ | 0.12 | 0.22% |
| Th | 37.7 | ThO₂ | 16 | 42.4% |

As Table 2 illustrates, the thermal conductivity of the oxide normally decreases at least two or more times, and in a lot of cases one order of magnitude or more, over that of the counterpart metal materials. This data demonstrates that the thermal properties of metal particles will deteriorate when they are oxidized. The use of polymer systems with low permeability of both oxygen and water prevent the oxidation of metal and increase the reliability of the thermal interface materials.

In some embodiments, tier the (E) other additive or optional materials, solvent or low molecular weight hydrocarbon resins can be used to homogenize and dissolve the polymer materials. The solvents can include normally organic solvents, however, high boiling point (e.g., >200° C.) solvents are typically preferred. Suitable resin materials include resins with molecular weights less than 2000, such as a hydrogenated resin. The resins can be natural or synthetic resins. The resins can be obtained by hydrogentation from ketone resins, polyamide resin, colophonium, coumarone resin, terpene resins. Examples are gas oil and terpene oil. Other materials include filler surface modification agents, wetting agents, gelling agents, cross-linking agents, rheology adjustment agents, colorants and fragrants.

The composition of highly reliable thermal interface materials includes: (A) moisture-resistant polymer with a water permeability coefficient preferably less than 10⁻¹¹ cm³ (STP) cm/cm² S Pa, (B) gas barrier polymer having oxygen permeability coefficient preferably less than 10⁻¹⁴ cm³ (STP) cm/cm² S Pa, (C) antioxidant, (D) thermal conductive filler and (E) other additive or optional materials.

The thermal interface materials placed in between the thermal generating and dissipating devices can create a barrier to water and oxygen penetration, preventing the thermal fillers from degradation and improving the reliability of the devices.

The following examples are intended to illustrate the invention to one skilled in the art and should not be interpreted as limiting the scope of the invention set forth in the claims.

### Example 1

### Thermal Measurement and Reliability Test

Thermal resistance measurements of the materials are carried out on a thermal test vehicle (TTV) which simulates the CPU heat dissipation structures. The CPU is a silicon chip embedded with heating elements and temperature probes. Between the silicon wafer and the heat sink is one layer of thermal interface material of initial 4 mil thickness, the setup is secured with 65 psi pressure with screw tight.

The reliability test is normally conducted by putting the sample, which is mounted, in the TTV test device in an oven at a given temperature, or in a humidity chamber or temperature cycling chamber.

### Example 2

### Materials and Sample Preparation

One example for the preparation of sample 1 is as follows: 100 g of hydrogenated olefin, which presents a low permeability to water is mixed with 60 g poly(imino-1-oxaundecamethylene) nylon 6 and 20 g of polytetrafluorethylene powder, which present low permeability to oxygen. To ensure homogenous mixing, heating may also be applied. To the above mixture 5 g of antioxidant is added, such as Ethanox 310, and a thixotropic agent such as Thixatrol Plus is also added. The filler materials for the thermal paste used are indium tin powders, which can account for as much as 85% of the weight of the paste.

As a comparison, sample 2 uses only polyol ester such as Hatcol 5150 as a suspension liquid to disperse the same metal filler.

Sample 3 is the commercially available thermal paste materials of Arctic Silver 5.

### Example 3

### Materials Performance—Thermal Acing

Thermal aging experiments are conducted and the test results are shown in Table 3. It is shown that the sample 1 is much more stable than samples 2 and 3.

TABLE 3

| Aged at 90° C. | Thermal resistance (cm2 K/W) | | |
|---|---|---|---|
| (hours) | Sample 1 | Sample 2 | Sample 3 |
| 0 | 0.140 | 0.142 | 0.150 |
| 500 | 0.143 | 0.187 | 0.201 |
| 1000 | 0.145 | 0.210 | 0.252 |

### Example 4

### Materials Peribrinance—Thermal Aging 85° C. and 85% Relative Humidity Test

85° C. and 85% relative humidity experiments were conducted and the test results are shown in Table 4. Despite some increase in thermal resistance for sample 1, it showed more favorable results than samples 2 and 3.

TABLE 4

| Aged at 85OC and | Thermal resistance (cm2 K/W) | | |
|---|---|---|---|
| 85% RH (hours) | Sample 1 | Sample 2 | Sample 3 |
| 0 | 0.145 | 0.140 | 0.136 |
| 500 | 0.198 | 0.317 | 0.270 |
| 1000 | 0.217 | 0.521 | 0.401 |

### Example 5

### Materials Performance—Power Cycling Test

Power cycling experiments were conducted and the test results are shown in Table 5. The power was set at 50 W with 3 min heating up and 2 min cooling down as a cycle. Lower thermal resistance is observed for sample 1.

TABLE 5

| Power cycling | Thermal resistance (cm² K/W) | | |
|---|---|---|---|
| (cycles) | Sample 1 | Sample 2 | Sample 3 |
| 0 | 0.142 | 0.153 | 0.137 |
| 2000 | 0.126 | 0.126 | 0.302 |
| 5000 | 0.115 | 0.130 | 0.380 |

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “hut not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A thermal interface material, comprising:
a polymer having a water permeability coefficient less than about 10⁻¹¹ cm³ (STP) cm/cm² S Pa;
a polymer having an oxygen permeability coefficient less than about 10⁻¹⁴ cm³ (STP) cm/cm² S Pa;
an antioxidant; and
a thermally conductive filler.

2. The thermal interlace material of claim 1, further comprising a solvent or low molecular weight hydrocarbon resin.

3. The thermal interface material of claim 1, wherein the polymer having the water permeability coefficient less than about 10⁻¹¹ cm³ (STP) cm/cm² S Pa and the polymer having an oxygen permeability coefficient less than about 10⁻¹⁴ cm³ (STP) cm/cm² S Pa are the same polymer.

4. An assembly, comprising:
a thermal generating device;
a thermal dissipating device;
a thermal interface material disposed between the thermal generating device and the thermal dissipating device, the thermal interface material comprising:
a polymer having a water permeability coefficient less than about 10⁻¹¹ cm³ (STP) cm/cm² S Pa;
a polymer having an oxygen permeability coefficient less than about 10⁻¹⁴ cm³ (STP) cm/cm² S Pa;
an antioxidant; and
a thermally conductive filler.

5. The assembly of claim 4, wherein the thermal interface material further comprises a solvent or low molecular weight hydrocarbon resin.

6. The assembly of claim 4, wherein the polymer having the water permeability coefficient less than about 10⁻¹¹ cm³ (STP) cm/cm² S Pa and the polymer having an oxygen permeability coefficient less than about 10⁻¹⁴ cm³ (STP) cm/cm² S Pa are the same polymer.

7. A method of making a thermal interface material comprising, combining:
a polymer having a water permeability coefficient less than about 10⁻¹¹ cm³ (STP) cm/cm² S Pa;
a polymer having an oxygen permeability coefficient less than about 10⁻¹⁴ cm³ (STP) cm/cm² S Pa;
an antioxidant; and
a thermally conductive filler.

8. The method of claim 7, further comprising combining a solvent or low molecular weight hydrocarbon resin with the combined materials.

9. The method of claim 7, wherein the polymer having the water permeability coefficient less than about 10⁻¹¹ cm³ (Si)') cm/cm² S Pa and the polymer having an oxygen permeability coefficient less than about 10⁻¹⁴ cm³ (STP) cm/cm² S Pa are the same polymer.

10. A method of forming an assembly, comprising:
applying a thermal interface material between a thermal generating device and a thermal dissipating device;
wherein the thermal interface material comprises:
a polymer having a water permeability coefficient less than about 10⁻¹¹ cm³ (STP) cm/cm² S Pa;
a polymer having an oxygen permeability coefficient less than about 10⁻¹⁴ cm³ (STP) cm/cm² S Pa;
an antioxidant; and
a thermally conductive filler.

11. The method of claim 10, wherein the thermal interface material further comprises a solvent or low molecular weight hydrocarbon resin.

12. The method of claim 10, wherein the polymer having the water permeability coefficient less than about 10⁻¹¹ cm³ (STP) cm/cm² S Pa and the polymer having an oxygen permeability coefficient less than about 10⁻¹⁴ cm³ (STP) cm/cm² S Pa are the same polymer.
